(19) United States
(12) Patent Application Publication
(10) Pub. No.: US 2020/0067121 A1
(43) Pub. Date: Feb. 27, 2020

(54) A REDUCTION-OXIDATION FLOW BATTERY

(71) Applicant: Siemens Aktiengesellschaft, Munich (DE)

(72) Inventors: Jochen Friedl, Newcastle Upon Tyne (GB); Timothy Hughes, Wantage (GB); Ulrich Stimming, Newcastle Upon Tyne (GB); Holger Wolfschmidt, Erlangen (DE)

(73) Assignee: Siemens Aktiengesellschaft, Munich (DE)

(21) Appl. No.: 16/612,683

(22) PCT Filed: May 8, 2018
(86) PCT No.: PCT/EP2018/061902

§ 371 Date: Nov. 11, 2019

(30) Foreign Application Priority Data
May 11, 2017 (GB) 1707568.0

(51) Int. Cl. H01M 8/18; H01M 8/04186; H01M 8/20

(52) U.S. Cl. CPC H01M 8/188; H01M 8/20; H01M 8/04186

(57) ABSTRACT

A reduction-oxidation flow battery including a first electrolyte storage tank configured to store an anolyte, and a second electrolyte storage tank configured to store a catholyte. A same polyoxometalate (POM) redox active species is used for both the anolyte and the catholyte. The same polyoxometalate (POM) redox active species includes XMoᵢTⱼOₖ or XWᵢTⱼOₖ. X=Si, P, Ge, or Al. T=Mn, Fe, V, Ti, Cr, Co, or Cu. i, j, and k are indices. i is in a range of 9 to 14. j is in a range of 1 to 3. k is in a range of 34 to 42.

### TECHNICAL FIELD

The present disclosure relates to reduction-oxidation flow batteries. More particularly, the disclosure relates to a selection of electrolytes for efficient energy storage and transfer.

### BACKGROUND

Flow batteries are described by the following documents:
H. D. Pratt, N. S. Hudak, X. Fang and T. M. Anderson, J. Power Sources, 2013, 236, 259-264;
T. Nguyen and R. F. Savinell in the Electrochemical Society “Interface” Fall 2010, pp. 54-56, by Q. Xu; and
T. S. Zhao in “Fundamental models for flow batteries”, Progress in Energy and Combustion Science 49 92015) 40-58, and by Pratt et al. in “A Polyoxometalate Flow Battery”.

The following US patents and patent applications also describe examples of flow batteries:

US 2016/0043425 A1;

US 2009/0317668 A1;

US 2014/0004391 A1;

US 2015/0349342 A1; and

U.S. Pat. No. 4,786,567.

Co-pending UK patent application GB1606953.6 (published as GB 2549708 A) also relates to Polyoxometalate Flow Batteries.

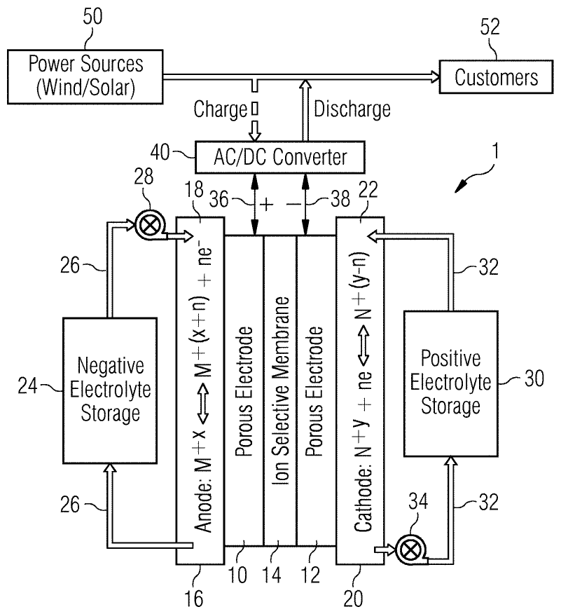

FIG. 1, taken from the Nguyen and Savinell article, schematically illustrates a flow battery 1. A porous anode 10 and a porous cathode 12 are separated by an ion selective membrane 14. A first electrolyte vessel 16 provides a first electrolyte solution 18 to the porous anode 10 on a surface directed away from the ion selective membrane 14. A second electrolyte vessel 20 provides a second electrolyte solution 22 to the porous cathode 12 on a surface directed away from the ion selective membrane 14. A first electrolyte storage tank 24 is linked to first electrolyte vessel 16 by pipes 26 and pump 28. A second electrolyte storage tank 30 is linked to second electrolyte vessel 20 by pipes 32 and pump 34.

First electrolyte storage tank 24 stores a “negative electrolyte” or “anolyte” 18. The anolyte takes part in electron uptake and release at a reduction-oxidation equilibrium which may be expressed as:

M^{x-}↔M^{(x-n)-}+ne⁻.

Second electrolyte storage tank 30 stores a “positive electrolyte” or “catholyte” 22. The catholyte takes part in electron release and uptake at a reduction-oxidation equilibrium which may be expressed as:

N_{y-}+ne⁻↔N^{(y+n)-}.

Because of the existence of these reduction-oxidation reactions, the anolyte and catholyte may be considered, and referred to, as “reduction-oxidation species”.

The flow battery 1 may be charged and discharged through anode connector 36 and cathode connector 38.

In a typical application, a renewable energy source 50, such as a wind, solar or tidal generator, provides renewable power to customers 52 at an AC voltage. However, it is required to be able to store some power generated by the generator 50 at times that demand by the customers 52 does not require the full amount of power generated by the generator 50, and to release the stored power at times that demand by the customers 52 exceeds the amount of power being generated by the generator 50. The flow battery may be used to store and release such power. It must first be converted from AC to DC by converter 40. When an excess of power is generated by the generator 50, positive and negative voltages from the generator are respectively applied to porous anode 10 and porous cathode 12. Electrons are drawn from the anolyte 18 and stored in the catholyte 22. Electrolyte molecules in the anolyte become more positively charged, while electrolyte molecules on the catholyte become more negatively charged. The electrolytes are circulated by pumps 28, 34 from the electrolyte vessels 16, 20 to the electrolyte storage tanks 24, 30. Storage of power within the flow battery may continue until all of the reduction-oxidation species of at least one of the anolyte and the catholyte are fully charged.

On the other hand, the drawing of power from the flow battery to provide to the customers 52 involves a reverse, discharging, process. In that case, electrons are transferred from the catholyte to the anolyte. This DC current is converted by the converter 40 into an AC current for supply to the customers 52.

Various combinations of electrolytes (anolyte/catholyte) are known, and each has its own characteristics. Some examples are provided in the paper by Nguyen and Savinell, mentioned above.

In an example of Vanadium-based electrolytes, the anode reduction-oxidation equilibrium reaction may be:

V²⁺↔V³⁺+e⁻

And the cathode equilibrium reduction-oxidation reaction may be:

VO₂⁺+2H⁺+e⁻↔VO₂₊+H₂O

In each case, it can be seen that each reduction-oxidation of the anolyte and catholyte ion species stores and releases a single electron.

Co-pending UK patent application GB1606953.6 (published as GB 2549708 A) provides combinations of electrolytes in which each reduction-oxidation ion species of the anolyte and catholyte may store and release several electrons.

Typically, the anolyte and the catholyte will be in aqueous solution, with a further supporting electrolyte. In the example Vanadium-based system outlined above, the supporting electrolyte may be sulphuric acid H₂SO₄, which dissociates in aqueous solution to H⁺ and SO₄²⁻ ions.

According to an aspect of the teachings of Co-pending UK patent application GB1606953.6, the catholyte and the anolyte are selected from among the respective following groups of polyoxometalate compounds:

Catholytes:

C₆V₁₀O₂₈ with cation C which is either H⁺, Li⁺, Na⁺, or a mixture thereof, or

(ii) C₉PV₁₄O₄₂ with cation C which is either H⁺, Li⁺, Na⁺, or a mixture thereof,

With a supporting electrolyte of one or a mixture of:

(i) Na₂SO₄;

(ii) Li₂SO₄;

(iii) LiCH₃COO; or

(iv) NaCH₃COO;

(v) HCl;

(vi) H₃PO₄; and

(vii) H₂SO₄.

The supporting electrolyte increases the solubility of the reduction-oxidation species, increases the conductivity of the catholyte and provides a balancing ionic flow through the membrane.

Anolytes:

(i) C₄SiW₁₂O₄₀ with cation C which is either: H⁺, Li⁺, Na⁺, or a mixture thereof.

(ii) C₄SiMo₁₂O₄₀ with cation C which is either: H⁺, Li⁺, Na⁺, or a mixture thereof.

(iii) C₃PW₁₂O₄₀ with cation C which is either: H⁺, Li⁺, Na⁺, or a mixture thereof.

(iv) C₅AlW₁₂O₄₀ with cation C which is either: H⁺, Li⁺, Na⁺, or a mixture thereof.

With a supporting electrolyte of one or a mixture of:

(i) Na₂SO₄;

(ii) Li₂SO₄;

LiCH₃COO; or

(iv) NaCH₃COO;

(v) HCl;

(vi) H₃PO₄; and
(vii) H₂SO₄.

The supporting electrolyte increases the solubility of the reduction-oxidation species, increases the conductivity of the anolyte and provides a balancing ionic flow through the membrane.

During charging the Tungsten or Molybdenum reduction-oxidation centres are reduced from W(VI) to W(V) or Mo(VI) to Mo(V) releasing one electron each.

The membrane 14 is required to be permeable to at least one ion of the cations of the supporting electrolyte, i.e. H⁺, Na⁺ or Li⁺ but to be impermeable to the reduction-oxidation species contained in the anolyte or catholyte. Suitable materials would be perfluorosulfonic acid membranes like Nafion® N117 from DuPont.

The combination of porous anode 10, ion selective membrane 14 and porous cathode 12 may be referred to as a “stack” or “flow plate”.

Use of electrolytes according to the teaching of co-pending UK patent application GB1606953.6 (published as GB 2549708 A) provides at least some of the following advantages.

As each reduction-oxidation species ion of the electrolytes of the present disclosure is capable of transferring multiple electrons, more efficient charging and discharging and a greater stored charge density is possible than with conventional vanadium ion based flow batteries.

The lower charge-transfer resistance of the polyoxometalate (POM) electrolytes as compared to vanadium electrolytes increases voltage efficiency and increases the power density.

The lower charge-transfer resistance of the POM electrolytes as compared to vanadium electrolytes reduces capital costs as a smaller power converter is sufficient. A smaller power converter reduces costs for membranes and cell components and reduces the geometric footprint of the battery.

Polyoxometalate (POM) electrolytes comprise large reduction-oxidation species ions, which exhibit slower permeation through the membrane than vanadium ions, which reduces self-discharge of the flow battery.

Polyoxometalate (POM) electrolytes can achieve a higher energy density than vanadium ions for a given volume of electrolyte, which may reduce the geometric footprint and therefore capital costs of the flow battery.

Polyoxometalate (POM) electrolytes as described for the catholyte are easily prepared, which minimises capital costs.

Polyoxometalate (POM) electrolytes described for anolyte and catholyte are stable in pH 2-3 which is less corrosive than commonly employed acidic solvents. This also may reduce capital costs as less stringent requirements are placed on associated storage vessels.

The polyoxometalate (POM) electrolytes of co-pending UK patent application GB1606953.6 (published as GB 2549708 A) allow the transfer of more than one electron with each reduction-oxidation species ion. The lower charge-transfer resistance of the POM reduction-oxidation species ions compared to vanadium ions enables faster charging and discharging, increased current output and higher current output per unit surface area of the membrane. A smaller membrane surface area may therefore be used, and/or a smaller volume of electrolyte, reducing system cost and system size, and/or improved charging/discharging rate and capacity may be achieved.

As the polyoxometalate (POM) electrolytes comprise relatively large reduction-oxidation species, they may be restrained by relatively thin membrane. Such membranes are likely to be relatively inexpensive. It is important, however, that the anolyte and catholyte species should be kept separate, without any degree of mixing.

Examples of suitable membrane materials include cation exchange membranes based on perfluorosulfonic acid polymer membranes such as Nafion® N117 by DuPont.

Polyoxometalate (POM) electrolytes have been found to dissolve more readily in aqueous solvents than some vanadium ion electrolytes, enabling a higher concentration of electrolyte to be produced and used.

With the Polyoxometalate (POM) electrolytes of co-pending UK patent application GB1606953.6, a given power output may be achieved with a smaller active area of membrane.

### DETAILED DESCRIPTION

The present disclosure does not propose any changes to the arrangement shown in FIG. 1, but rather proposes particularly advantageous combination of electrolyte species.

The above, and further, objects, characteristics and advantages of the present disclosure will become more apparent from the following description of certain example embodiments, given by way of examples only, in conjunction with the accompanying drawing, wherein:

FIG. 1 illustrates an example structure of a conventional flow battery.

According to the present disclosure, the anolyte and the catholyte are polyoxometalate (POM) electrolytes. The present disclosure provides an all-polyoxometalate (POM) electrolyte symmetric flow cell, in which a same polyoxometalate (POM) redox active species is used for both anolyte and catholyte.

The redox active species in the anolyte and catholyte M is a POM with formula:

XMoᵢTⱼOₖ or XWᵢTⱼOₖ, wherein:

X=Si, P, Ge, or Al; T=Mn, Fe, V, Ti, Cr, Co, or Cu;

i, j, k as indices;

i is in the range of 9 to 14 but is preferably 9;

j is in the range of 1 to 3, but is preferably 3; and

k is in the range of 34 to 42, but is preferably 34.

The concentration of redox active species is preferably greater than 20 mM/litre, and more preferably greater than 500 mM/litre in electrolyte.

The supporting electrolyte comprises one or a mixture of:

Na₂SO₄;

Li₂SO₄;

LiCH₃COO;

NaCH₃COO; and

H₃PO₄.

The supporting electrolyte increases the solubility of the polyoxometalate (POM) electrolyte reduction-oxidation species, increases the conductivity of the anolyte and provides a balancing ionic flow through the membrane.

1-5. (canceled)

6. A reduction-oxidation flow battery, comprising:
a first electrolyte storage tank configured to store an anolyte; and
a second electrolyte storage tank configured to store a catholyte,
wherein a same polyoxometalate (POM) redox active species is used for both the anolyte and the catholyte, the same polyoxometalate (POM) redox active species comprises XMoᵢTⱼOₖ or XWᵢTⱼOₖ, where
X=Si, P, Ge, or Al,
T=Mn, Fe, V, Ti, Cr, Co, or Cu,
i, j, and k are indices,
i is in a range of 9 to 14,
j is in a range of 1 to 3, and
k is in a range of 34 to 42.

7. A reduction-oxidation flow battery according to claim 6, wherein i=9.

8. A reduction-oxidation flow battery according to claim 6, wherein j=3.

9. A reduction-oxidation flow battery according to claim 6, wherein k=34.

10. A reduction-oxidation flow battery according to claim 6, wherein the anolyte and the catholyte are each provided in an aqueous solution with a supporting electrolyte of one or a mixture of any of Na₂SO₄, Li₂SO₄, LiCH₃COO, NaCH₃COO, and H₃PO₄.
